(19) United States
(12) Patent Application Publication
(10) Pub. No.: US 2010/0259389 A1
(43) Pub. Date: Oct. 14, 2010

(54) Forgetmenot, radio-frequency identification (RFID) system with verifying interconnected units

(76) Inventor: Vernon Kent Marshall, Bronx, NY (US)

Correspondence Address: Vernon Kent Marshall, 2807 Claflin Avenue, Apt. 35, Bronx, NY, 10468, US

(21) Appl. No.: 12/798,584

(22) Filed: Apr. 6, 2010

Related U.S. Application Data
(60) Provisional application No. 61/212,123, filed on Apr. 8, 2009.

(51) Int. Cl. G08B 13/22

(52) U.S. Cl. 340/572.1

(57) ABSTRACT

A method of using a plurality of units that can be attached to designated article that should remain in close proximity of one another. And if any of the units were to be separated, an alert would be given with indications of which unit(s) is not present.

### CROSS REFERENCE TO RELATED APPLICATIONS

This application claims the benefit of U.S. Provisional Patent Application No. 61/212,123, which is incorporated by reference herein.

### FIELD OF THE INNOVATION

The present innovation relates to a method and/or application used as an aid for help in preventing the user of the innovation from forgetting something(s) by use of interconnected units. The innovation uses radio Frequency Micro Device (RFMD) and Radio Frequency Identification RFID with a plurality of unit(s) that seek to frequently inquire (Ack requests) of the presence of all other active units that are part of the set and alert to, by various means, that one or more unit(s) has failed to register an Ack reply, and therefore assumes unit(s) is not present, resulting with alert being triggered.

### BACKGROUND OF INNOVATION

The innovation is described with reference to an example set and henceforth will be referred to as the BASIC EXAMPLE SET or (BES). The BES is comprised of three units (unit tablets A,B,C) that make up the set, but persons skilled in electronics will recognize that the objective(s) is/are not limited to present approach. A software solution could and can be incorporated and applied in such a way so as to achieve said objective.

Too many times have I found myself in a position where I left something(s) behind at a place had I just left and it, whatever it was that I had forgotten, was absolutely essential that it was with me; Other times I've found myself looking for one or more of these essential articles (keys, cell phone, bag . . . ) while I was pressed for time. As a means of avoiding these types of scenarios, I recognized a need and use for a device to help me solve this problem. Thus I attempted to devise something to do so and ended up with present innovation.

Track and locate systems using RFMD technology have been in prevalent use for some time now and have been in existence for over 40 years. A search of the USPTO database will result in hundreds of RFID-related and RFMD-related patents. The technology can be found at work in many ways, ranging from uses such as: animal trackers, controlled access devices, theft detection, inventory management, to toll collection and more. The following is a list of some of the search results of which the innovation was measured against and evaluated in comparison to: U.S. Docket Number 6,577,238 Item 1-A published/issued Jun. 3, 2003 patentee, Whitesmth, U.S. Docket Number 6,747,560 item 2-B published/issued Jun. 8, 2004 patentee, Stevens U.S. Docket Number 6,774,782 item 3-C published/issued Aug. 10, 2004 patentee, Runyon U.S. Docket Number 7,019,639 Item 5-E published/issued Mar. 28, 2006 patentee, Stilp.

### SUMMARY OF THE INNOVATION

The present innovation provides for a method/application that uses, but is not limited to, RFID and/or other communication means, with a set of designated items (unit(s)) and/or items associated with the unit tablet(s), that perform the function of frequent inquires (Ack Request) on all other active unit tablets that are part of the same set/group. Each active unit tablet has uniquely ID coded signals relative to each of the other unit tablet(s) that is/are part of the set. Please see FIGS. 11 & 12. While in the main communication mode, for every active tablet in the BES, at least four (4) coded signals are used between any two active unit tablets and are unique in purpose and character specific to the targeted unit tablet(s) that are part of the same set. The communication signals carry the instruction codes as well as all other, except for some codes. Please see FIG. 13.

Each of the three unit tablets sends out polling signals called an Acknowledgement requests (Ack request) that are specifically coded for the other targeted unit tablets. Under normal communication mode, the special instruction command part of the communication code string would have a negative indicator (0). This would tell the receiving (hearing) targeted unit tablet(s) that there is no command, such as locate command, and deactivate command or others. The other active unit tablets that are part of the set will respond by sending back the specific signal codes, Ack replys that are taken as an acknowledgement(s). See Example 1. The issuing unit tablet, once it hears the Ack reply; will then record a present status (1) in its registry that is assigned to the targeted unit tablet(s). This is done every (value to be defined) seconds. If there is a failure to register in the issuing units' registry(s) for the targeted unit(s), an alert is to be triggered. Alerts/alarms can also be triggered by Motion Sensory Activation, Location commands, Deactivations and others to name a few.

For the purpose of this description, the BES will be used with unit tablets A, B & C. The unit of measurement is that of Signal Strength. With the BES, units A, B & C would each send out a unique outgoing signal to each of the other units that are part of the set. Please see FIG. 2. The outgoing signal is coded so as only the intended unit will recognize and receive it. The outgoing signal will be requesting an Ack reply signal that is also a unique reply signal from the responding unit. The codes are pre-programmed into the units. For example of Communication Ack request and Ack reply codes see FIG. 15.

### BRIEF DETAILED DESCRIPTION OF THE FIGURES

FIG. 1: shows basic abstract concept of the interconnectivity between Units in BES. Arrows between Units represent the Ack request & Ack reply communications

FIG. 2: shows details of concept in abstract form

FIG. 3: definitions of diagram in FIG. 2

FIG. 4: example of Units in position showing all units within acceptable parameters of each other for a BES

FIG. 5: example of units positioned showing invention giving alerts when one unit is separated and fails to give or register an Ack reply with the BES

FIG. 6: example of units positioned showing invention giving alerts when two units are have failed to give an Ack reply(s) with the BES

FIG. 7: example of units positioned showing invention giving alerts when all units to give Ack reply(s) with the BES

FIG. 8: example of what the Ack request &Ack reply communication code string between units A&B and between units A&C looks like with a BES

FIG. 9: example of what the Ack request &Ack reply communication code string between units B&A and between units B&C looks like with a BES

FIG. 10: example of what the Ack request & reply communication code string between units C&A and between units C&B looks like with a BES

FIG. 11: figure shows communication code format

FIG. 12: a table defining the Ack request & reply symbols for the BES

FIG. 13: a table showing the binary codes for Commands

FIG. 14: a table showing Signal Frequency Options

FIG. 15: communications string code for an Ack request & an Ack reply

FIG. 16: string codes for Unit Identification

FIG. 17: string code for Read command

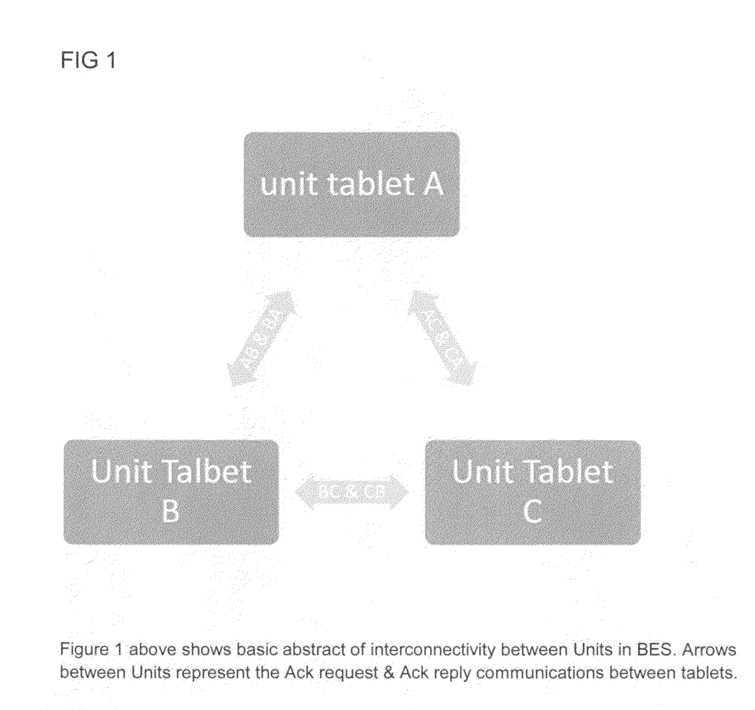

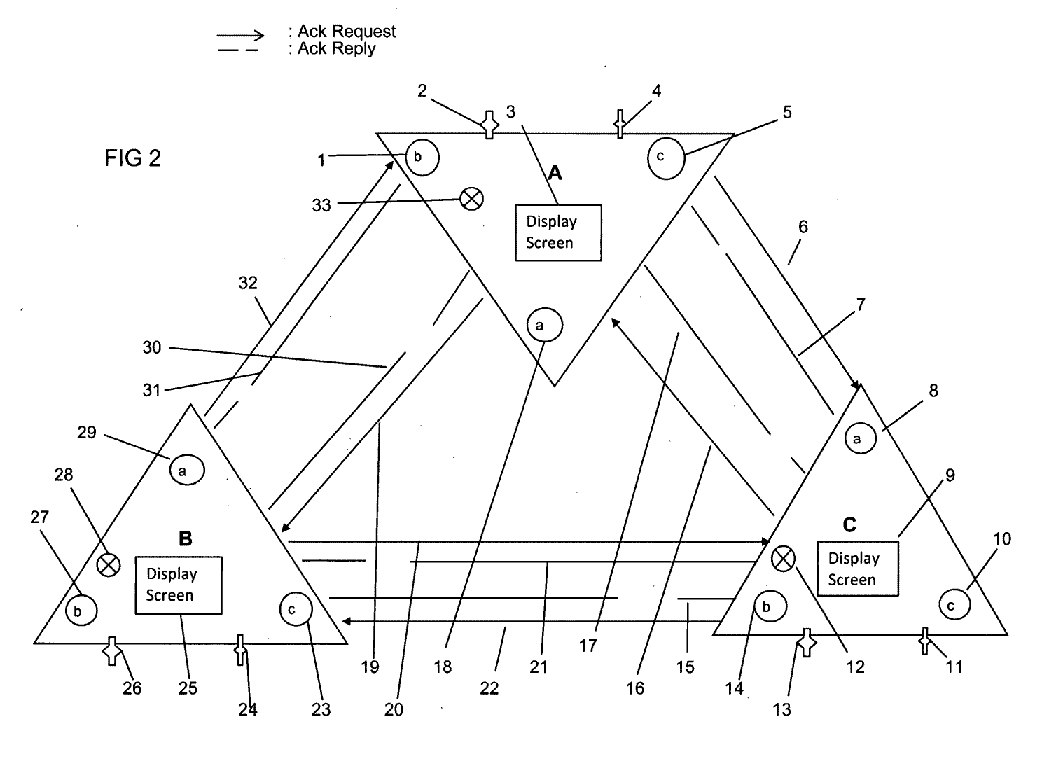

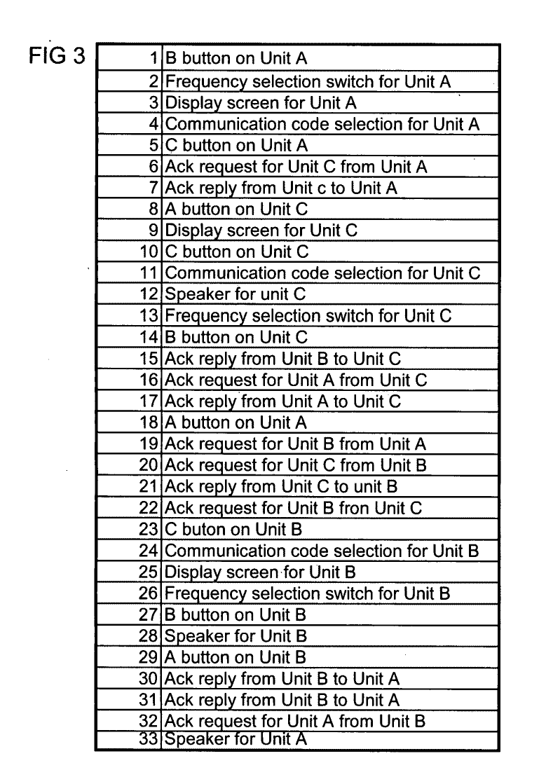

### DESCRIPTION OF INNOVATION AND HOW INNOVATION WORKS

The main description of the innovation consists of multiple units (unit tablets) that serves the purpose of frequent inquires (Ack request) on all other active units that are part of the set/group. Each active unit has unique ID coded signals relative to each of the other unit(s) (unit tablet(s)) that is/are part of the same set. While in main communication mode, for every active unit tablet, four uniquely coded signals are used for each of the other targeted unit(s) (unit tablets) that is/are part of the same set. The unit of measurement is that of signal strength equivalent. The innovation also incorporates additional features and functions and can operate in various modes that are designed to further assist user of said innovation. The following is a list of some of these modes and functions are: Security mode, Location mode, Deactivation mode, Silent mode, Visual mode, Non-visual mode, Main comm. Mode, Non interference delineation feature and pass along feature to name a few.

### What the Innovation is Comprised of and the Basic Components and Mechanisms

The BES is made up of units A, B & C. Each unit consist of an antenna (coiled and/or incorporated into casing), a Digital Signal Processor, an Analogue to Digital Converter, Signal Strength Detector, DC power supply, audio alert mechanism, motion sensor, light diodes, vibration mechanism, transceiver—receiver, battery strength test function, power capacitor, programmable IC (Intergraded circuitry) chip, button(s) mechanism(s), signal amplifier, clock/timer function and (optional, LED, deaf mode) and other components.

### How it Works:

Each active unit can be attached to something that is important enough not to forget anywhere. The unit set can come with units that are not all uniformed in shape and size. For example while the other units are the same in shape, one could be in the shape of a thick credit card so as to allow, for use in a wallet.

### Examples of Usage:

Wallets, passports, keys, handbags, credit cards, cell phones, laptop computers, ect; can be attached to units. When any one or more of these units are out of a pre-set signal strength radius equivalent (SSRE) range, an alarm will activate on all active unit tablets and the button(s) that correspond to the units that failed to respond, will light up, indicating which one(s) has failed, alerting to the fact that something may not be with user. If units A & B are with you, and unit C is not (See FIG. 15), alarm will activate on both A & B units and the c buttons on unit tablets A & B will light up. While simultaneously on unit C, the alarm will activate, and the b and a buttons will light up. Each of the three unit tablets sends out two polling Ack request that are specifically coded to the other targeted units. The other units will respond by sending back the specific Ack reply codes that are taken as an acknowledgement. This is done every (value to be defined) seconds. If an ack reply code is not received (heard/registered), an alert will activate on all active units that registered a non-ack reply. The Signal strength Radius Equivalent (SSRE) at which unit(s) will not be able to contact other units can be set according to a pre-set signal strength distance standard. Time interval for the polling can be set according to pre-set times. Unit(s) will alert if there is a weak battery. The units have a deactivator option that will remind with a flash and or audio and/or in display box that one or more units have been deactivated. While in Deactivate with reminder mode, ever (Value to be defined) hours, set alerts to deactivated units.

### DETAILED DESCRIPTION OF FUNCTIONS, OPTIONS AND FEATURES

### Interference Prevention

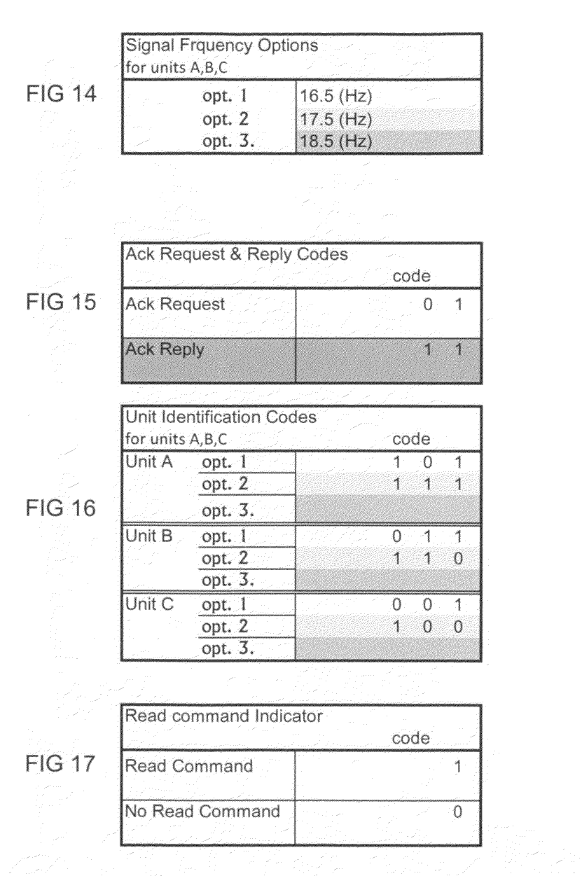

To reduce the chance of interference from multiple users of the innovation within close proximity of one another; the set can be adjusted by selecting from a pre-programmed selection of wave frequency(s) to be used for the signal broadcast. See FIG. 14. In an improved more advanced version, programming of units for most all features and functions, could be entered in on one unit that would then be remotely communicated and programmed for the other active units of the set. And a second differentiator to be used in combination with the first differentiator will be for the user to FIG. 16. Example: The number of unique COMMUNICATION code signal for a three unit set would require 12 unique signals, of which each code signal would be assigned a discrete numerical value in the target section of the code string. See FIG. 16. These values can be base 2, base 8, base 16 ECT . . . . For example, user selects pre-setting 1. The discrete numerical values assigned to the target section of code string for the associated COMMUNICATION code would/can range from 0001 (1) to 0011 (3). If pre-setting 2 is selected, the discrete numerical values assigned to the target section of code string for the associated COMMUNICATION code labels would/can range from 0100 (4) to 0110 (6). If pre-setting 3 is selected, the discrete numerical values assigned to the target section of code string for the associated COMMUNICATION code labels would/can range from 0111 (7) to 1001 (9). See FIG. 16

### Communications

With the BES, Unit Tablets A, B & C would each send out a unique outgoing signal (Ack request) to each of the targeted unit tablets that are part of the set. The outgoing (Ack request) signal is coded so as only the intended Unit Tablet will recognize, receive and process it. The outgoing (Ack request) signal will be requesting an acknowledgment reply signal. The Ack reply signal from the replying unit is also a uniquely coded signal that identifies from which Unit the reply comes from and is a unique signal from the responding unit to the requesting unit. For an example of Communication signal codes, see FIG. 15. The codes are pre-programmed into the tablets of the units.

### Initiation of Communication Polling

There are multiple ways a polling ping can be initiated. Initiation of polling may or may not depend on innovation mode. The basic polling request is initiated every (Value to be defined) seconds and runs continually on a pre-set schedule while system is active/on. The pre-set time schedule of the polling depends on what mode the innovation is operating in. An override/priority initiation can trigger a polling routine. Barring an override/priority request, the normal procedure of operation for the polling schedule would have each active unit send out a unique coded Communication outgoing acknowledgement request signal. This outgoing acknowledgement signal would be requesting from the targeted tablet(s) an Ack reply to be sent back to the requesting

Unit, as well as to the other two active Units. This routine repeats every (Value to be defined) seconds.

In the case where the requesting unit (Unit A) does not receive back an Ack reply from the targeted Unit (Unit tablet B) within a defined period of time, the requesting Unit tablet's Integrated Chip (IC) processor that is in Unit tablet A, will register a Non-Ack reply for the specific outgoing Ack request signal (A→B). As a result of unit Unit A registering a Non-reply for its outgoing Ack request, an alarm/alert would be triggered on Unit tablet A, indicating that unit B failed to register. On Unit tablets A and C, a combination of all or some alerts can be used, depending on what mode of alert/alarm was selected and will indicate that unit B is not there; while at the same time unit B will be indicating that units A and C are not there.

In the case of a light diode & sound/audio alarm selection, the result would be the button(s) that corresponds to the unit(s) (targeted unit(s)) of which a non-Ack reply was registered, flashing/blinking and an audio alarm sounded. The user could then deactivate or re-set unit(s) by pressing the lit button with the specific pattern of pressing commands. The polling and/or the alert would still be active, even if the unit(s) that failed to reply were back within the SSRE and sending Ack reply(s). Alarm/alert will remain in effect until a reset and/or deactivate command is given. Example: pressing flashing B button on unit tablet A with three quick presses could/would result in resetting unit tablet A and sending out the reset command to the other units in the set. By pressing and holding the B button on any of the units for an extended period of time (3-5 Seconds) a deactivate command would be registered and sent out to the other units.

### Security Mode

When in security mode, the effective SSRE of an outgoing ack request signal is reduced to a (Value to be defined) strength/range and/or motion detector sensitivity is increased. The user can initiate security mode for all units or initiate security mode for selected unit(s) of the set. When a general security mode is activated, effective SSRE of an Ack request signal for all other unit(s) in set is/are reduced to a (Value to be defined) strength/range and/or motion detector sensitivity is increased. When selective individual unit(s) is/are set for security mode; all other non-selected units are set to security mode. Example: If unit tablet A in the BES has been selected for security mode, the result would be unit tablet B and unit tablet C being set to security mode via command broadcast. The effective SSRE of the Ack request signals are reduced for unit tablets A and B only. While unit tablet A, the selected unit for security mode, remains with a non-reduced SSRE for its Ack request signals. This allows the selected unit(s) to remain in close proximity.

### Temporary Security Mode

Temporary security mode=TSM

When in TSM mode, all active units in the set will go into Security Mode for a pre-set period of time (Value to be defined) seconds; After set time is reached, set would revert back to previous set mode it was operating under before the TSM mode was triggered. This mode would typically be triggered by a motion sensory initiation (MSA).

### Locate Command and Subroutine Initiation

The Locate command can be manually activated and initiated by user. Other examples with the BES, if a selected button is quickly pressed on any of the other active units in the set using a specific pattern, so as to issue the desired command, for this a button-pressing pattern of pressing X 2 will be used to issue the Locate command. The targeted unit(s) that would correspond to the selected unit being issued a Locate command signal from the originating unit(s), in this case it would be unit tablet A. This locate command would also be broadcasted by all other active units that heard the Locate-A command which was issued by/from the originating unit(s) (unit tablet A). This is done for all active units, except for the targeted unit(s). When a Locate command is issued, the SSRE is increased. This would/can increase the scope of signal effectiveness. Example: With BES, units A, B and C are spaced apart at an 180* angle (straight line) and unit B is within the increased SSRE range of both unit s A & C, but unit A is outside of the increased SSRE range of unit C. The Locate-C command that was issued by unit tablet A, would not be able to reach unit tablet C (the targeted unit). But because unit B would be able to hear the Locate command issued by unit A, unit B would issue a locate command broadcast for unit C (the targeted unit) that would be able to reach unit C. unless a Locate Ack reply is received and registered, the locate command for the targeted unit is repeated every (Value to be defined) seconds. The button(s) that correspond to the targeted unit(s) would be lit in a pattern (pattern to be defined) that would indicate a Locate-C command was issued. The other units that heard the Locate-C command would broadcast (Pass-along feature) a Locate command for the targeted unit(s), while in Locate mode. The button(s) for the targeted unit on both units change signaling pattern (final signal pattern to be defined) on any of the other units that comes within the SSRE range of (Value to be defined) feet of targeted unit(s) so as to indicate distance proximity between units. The targeted unit(s′) button(s) alert indicator that correspond to it on all active unit(s) within the SSRE range of the targeted unit(s), will go from one state to another. Once unit(s) is/are found, a deactivated, reset or locate command must be manually issued. Locate command can be accompanied by an audio/sound alarm/alert, solid beeps and/or intermitting beeps. An advanced version of the innovation could work with a pre-recorded verbal message (wav.file) saying something like “I′m over here” could be sounded from the targeted unit(s). The hearing Unit(s) will read the segment of code that says it's a locate command.

But if segment that shows targeted unit info is not a match, then the reading Units will broadcasts locate command with targeted data for segment.

### Motion Activation Interruption

### Motion Sensor Activation=MSA

A MSA has a priority interrupt status. This means that no matter where in the polling schedule the set was, a MSA procedure can start in TSM mode at any point. A first activation with no MSA for (value to be defined) minutes prior, will have a value to be defined second delay before a TSM Ack request polling is started. A motion activated interruption will automatically initiate a 15 Second delayed polling procedure in TSM mode. This is will happen if the unit(s) has not activated the motion sensor for the prior period of (Value to be defined) seconds. But if there was a MSA triggered within the time period allowed, any subsequent MSA would be blocked from be used for Value to be defined amount of time.

This is good for the case where someone is somewhere for a period of time, then go to leave in a hurry and may leave something behind. After a MSA polling, the regular polling schedule resumes. This is done so as to not have a MSA routine triggered back to back, when someone is in frequent motion that is strong enough to exceed the sensitivity threshold, the units can inquire other units' clocks and program polling schedule, so as not to have polling go out at the same time.

Deactivate Command (with Reminder or Without Reminder)

A Deactivate command can be manually activated. With the BES, if the user, for purpose of illustration, quickly presses a selected button on any of the active units in the set in a specific pattern so as to issue the desired Deactivate command, for this case we will use a 3× button press to issue a Deactivate command, the result would be for that unit(s) (the targeted unit(s)) that corresponds to the selected button being issued a Deactivate command signal from the originating issuing unit(s), in this case it would be unit tablet A. Please see FIG. 13 for command codes. This Deactivate command would also be broadcasted by all other active units unit(s) that heard the Deactivate-A command issued by/from the originating unit(s). Units would test to see if the command was for itself, if not, the deactivate command would be broadcasted by the hearing unit(s). Unless a Deactivate acknowledgement reply is received and registered, the Deactivate command for the targeted unit is repeated (every value to be defined) seconds. The buttons that correspond to the targeted unit(s) will signal in a way so as to indicate that a

Deactivate Command has been Issued.

The use of RFMD in the area of tracking, location and other uses a well established means of communications. There are many products in use that in one way or another use RFMD and locate techniques to help solve a problem of not being able to find, locate and/or remind for something that may be lost. Some examples are as follows: A) I am aware of an innovation that helps the user locate item(s)/article(s) that have some type of tag that would give off an alert when the user manually presses a find button on main control unit. These types of approaches mainly use some type of a transceiver and receiver setup that is separate from one another, to achieve this. B) Other set ups have various tags attached to articles such as clothing and merchandise and is able to track, non-arch distance movement. This also from my understanding uses a type of transceiver, transponder and receiver technique method with a main controller. This technology and techniques have been used in electronic fencing for say animals.

### Distinguishing Aspects

Although some aspects of the ForGetMeNot can/may be found in some form or another in some of the products that are already on the market, I believe the ForGetMeNot differs itself from anything I′ve seen so far that's out in the public in a number of ways. A) With the ForegetMeNot, both transceiver and receiver are incorporated into each unit. While With other approaches that I am aware of, the use of a Transceiver and receiver setup is often employed. Where with the transceiver is in a separate unit from that of the other unit(s) that would often have the receiver in it. B) With the ForegetMeNot it is not necessary for the main purpose function to be manually invoked. While With other approaches that I am aware of, the devices/methods may require a manual start to invoke main purpose function of idea. C) With the ForegetMeNot it can come with an active reminder. Others may not have that feature. With the ForegetMeNot, remote programming and updating. With the ForegetMeNot, Pass along feature.

1. A method and or approach/application that consist of a plurality of interconnected units that automatically inquire (a process called polling) for and to verify the presence of other units by use of pre-coded radio-Frequency identification (RFID) & radio-Frequency Micro Devices (RFMD) technologies, for the transmission and response (reply) of the communications messages between all active units of the set(pings) and of which the main function of the innovation is to reduce the risk of the user from forgetting item(s) that is/are associated with the innovation; the units of the innovation are part of a set, and by use of a self-initiating inquire and verification procedure, the units of the set work in unisons with all other units that are part of that set, and alert user if he/she does leave any item that is attached to one the active units of the set that becomes separated beyond a pre-defined signal strength radius equivalent (SSRE) and/or register a failure to verify and/or register an Ack reply, a pre-selected alert is triggered.

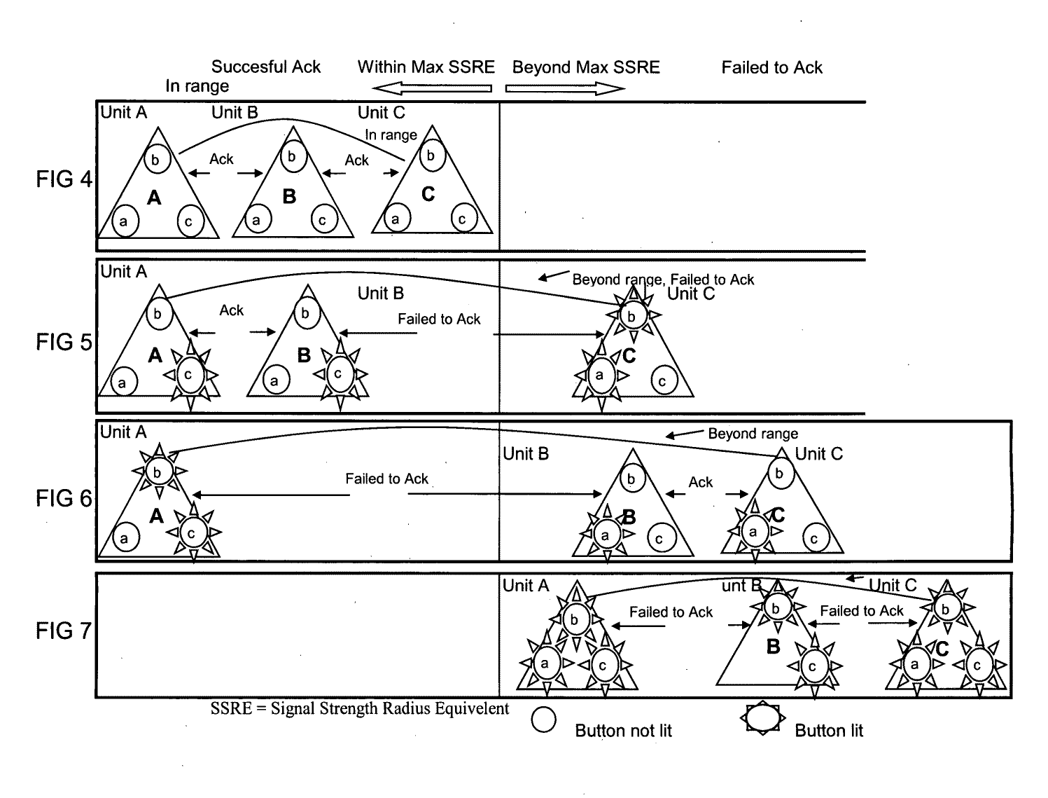

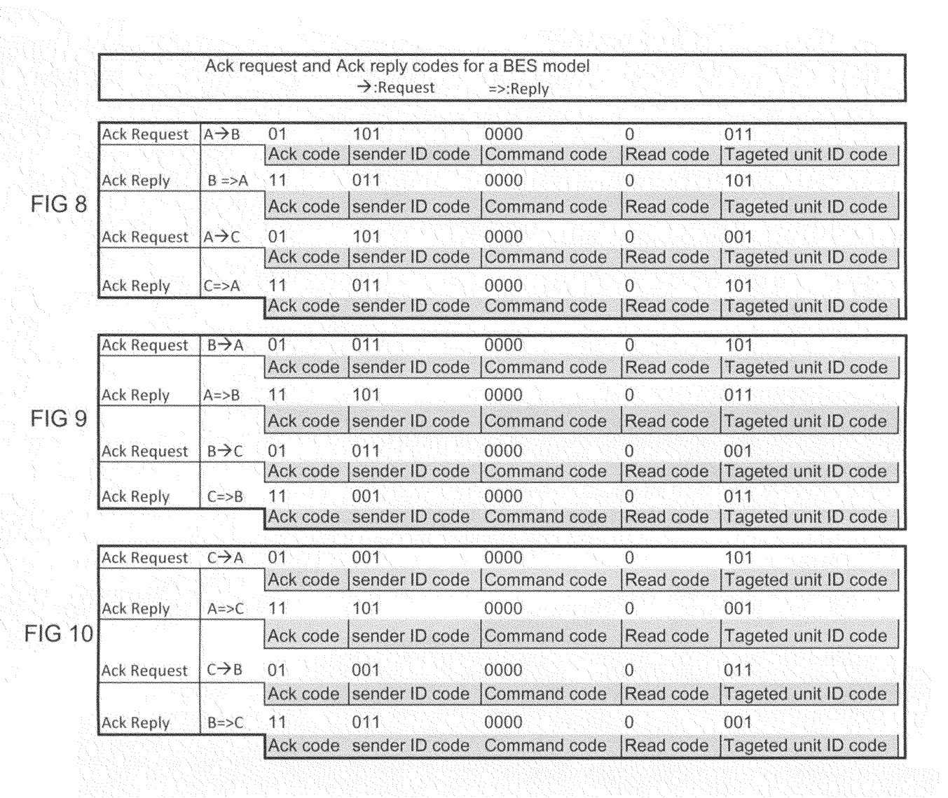

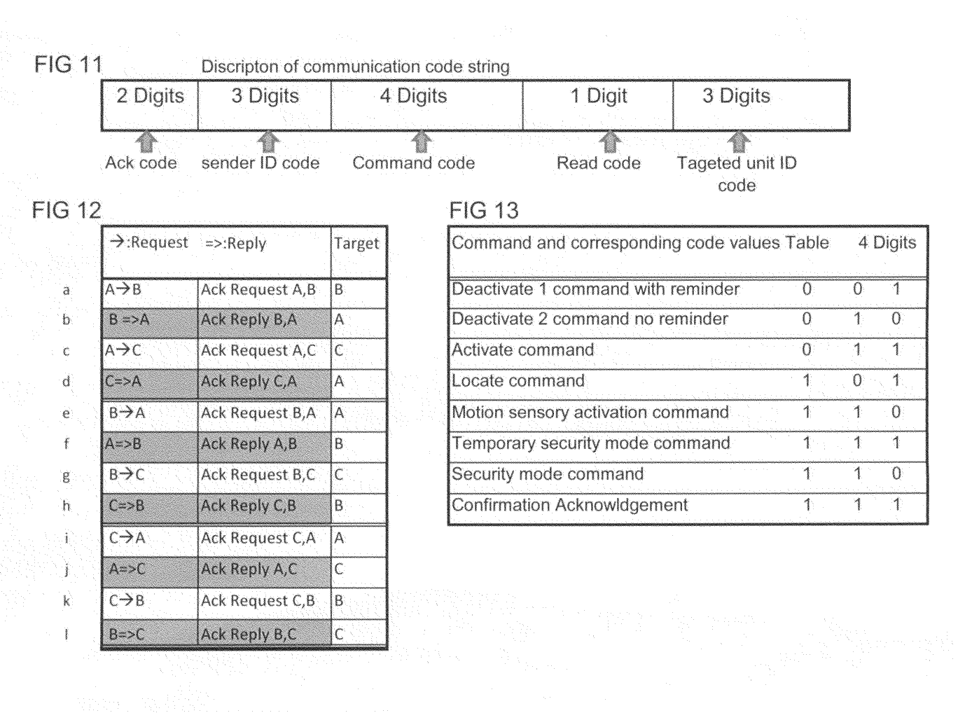

2. The unit(s) recited in claim 1, that has/have failed to be verified as present for the registry that is on the unit that issued the inquiry (Ack request), will be indicated by use of a combination of various forms of alerting options, such as: visual (light diodes), auditory (including way format), and vibration, on both and/or all other active units that are part of set and failed to be verified. Please see FIG. 4-7.

3. The procedure and method recited in claim 1, by which the verifying process is, but not limited to being, self initiating and does not necessarily require manual initiation.

4. The innovation recited in claim 1, has a number of value added features that can be helpful to user and are listed as follows: a) Locate, b) Motion Sensory Activation, c) Deactivate Command, d) Deactivate with Reminder command, e) Temporary Security Mode (TSM), f) Security mode (SM), g). Pass-along feature, h) Non-interference selections, i) Brail friendly feature.

5. The set recited in claim 1, can have more or less units associated with it by use of programmable Integrated Chip (IC) logic chips.

6. The feature recited in claim 1, calls for all units to have the ability have a polling procedure be initiated by detection of motion that is detected beyond a pre-set threshold of motion sensitivity level.

7. The Motion sensitivity level recited in claim 6, is to be adjustable.

8. The Motion activated polling routine recited in claim 1, has a delayed start of (Value to be Defined) seconds, when any one of the Units detects motion beyond motion sensitivity threshold; After a first motion activated routine, a block on motion activation goes into effect for a pre-set amount of time (Value To Be Defined). Primary polling schedule always remains in place.

9. The locate feature recited in claim 4, will issue a locate command that can be heard by other units of set and broadcasted with a boosted signal strength radius equivalent for a targeted unit and.

10. The Temporary security mode (TSM) recited in claim 4, will result in the signal strength radius equivalent (SSRE) of an acknowledgement request signal is reduced to a (Value to be defined) and/or motion detector sensitivity level increased to an amount.

11. The non-interference feature recited in claim 1, is a feature where as the user can set/adjust his/her set to a pre-programmed selection of wave frequency(s) to be used for the signal broadcast and a second differentiator that allows for the user to set/adjust his/her set by selecting from a pre-programmed selection of code ranges.

12. The pass-along mode recited in claim 4, gives all units that are part of set the ability to hear certain commands and rebroadcast them.

13. The alerting options recited in claim 4, can come in the following: audio, verbal, visual, vibration, flashing diodes and or in a combination of the fore mentioned.

14. The coded message recited in claim 1, uses a format that has a command section, poling section, sender id section, target id section and command indicator section.

15. The targeted recited in claim 1, will result in an indication of failed reply using an alert procedure indicates on all active unit(s) which unit(s) has failed to reply using light diode(s) as well as other means of communicating status.

16. The deactivation with reminder feature recited in claim 4, will remind user of set by indication of alert methods, that unit(s) is deactivated.

17. The ability to program set as recited in claim 1, to add and/or reduce the number of active units in a set.

18. The ability recited in claim 1, to remotely update and program other units in set.
